(19) United States
(12) Patent Application Publication
(10) Pub. No.: US 2024/0067203 A1
(43) Pub. Date: Feb. 29, 2024

(54) Apparatus and Method for Assisting a Driver of a Motor Vehicle in Driving on a Predetermined Racetrack

(71) Applicant: Bayerische Motoren Werke Aktiengesellschaft, Muenchen (DE)

(72) Inventors: Florian FEHR, Grasbrunn (DE); Florian HUELSMANN, Muenchen (DE); Tobias KAGE, Furth (DE)

(21) Appl. No.: 18/280,290

(22) PCT Filed: Mar. 1, 2022
(86) PCT No.: PCT/EP2022/055027

§ 371 Date: Sep. 5, 2023

(30) Foreign Application Priority Data
Apr. 22, 2021 (DE) 10 2021 110 237.5

(51) Int. Cl. B60W 50/14; B60L 15/20; B60W 50/08; F02D 41/00; F02D 41/30; F02P 5/15

(52) U.S. Cl. CPC B60W 50/14; B60L 15/20; B60W 50/085; F02D 41/0002; F02D 41/3011; F02P 5/1502; B60W 2050/146; B60W 2420/42; B60W 2520/28; B60W 2530/13

(57) ABSTRACT

Apparatuses, systems, and methods are provided for assisting a driver of a motor vehicle in driving on a predeter-mined racetrack. A sensor system is configured to detect a current position of the motor vehicle on the racetrack and an electronic control unit configured to control an actuator system of the motor vehicle. Predetermined brake point positions of the racetrack are stored in the electronic control unit. A current position of the motor vehicle on the racetrack is continuously detected. A relevant remaining driving time from the current position to a relevant brake point position of the racetrack is determined using the electronic control unit. Corresponding limit values are stored in the electronic control unit for the relevant remaining driving time. When a corresponding limit value is not reached, the control device controls the actuator system of the motor such that the motor generates a signal to the driver.

### BACKGROUND AND SUMMARY OF THE INVENTION

The present subject matter relates to an apparatus and a method for assisting a driver of a motor vehicle in driving on a predetermined racetrack.

The indication of an optimal or desired braking point may be represented on an indicator instrument. A disadvantageous aspect of this is that the driver is distracted from the racetrack or—to be more exact—from what is happening on the racetrack by even a brief glance at the indicator instrument.

It is therefore an object of the present subject matter to make an apparatus and a method available for assisting a driver of a motor vehicle in driving on a predetermined racetrack, with which an assistance of the driver is improved.

In accordance with the present subject matter, a method is proposed for assisting a driver of a motor vehicle in driving on a predetermined racetrack. The motor vehicle exhibits a sensing system, for detecting a current position of the motor vehicle on the racetrack, and an electronic control unit for regulating an actuating system of an engine of the motor vehicle. Furthermore, predetermined braking-point positions on the racetrack have been stored in the electronic control unit. The method comprises, firstly, a continuous detection of the current position of the motor vehicle on the racetrack and, subsequently, an ascertainment of a respective remaining driving time from the current position to a respective braking point on the racetrack by means of the electronic control unit. In addition, corresponding limiting values for the respective remaining driving time have been stored in the electronic control unit, and, in the event of a corresponding limiting value being fallen short of, the control unit regulates the actuating system of the engine in such a manner that the engine generates a signal for communication to the driver.

An advantageous aspect of this is that the remaining travel-time up until the optimal or desired braking point is ascertained on the basis of the identification of the position on a predetermined racetrack. The braking-point is communicated to the driver in concrete terms at the given time by purposeful activation of the engine. The gaze of the driver does not have to be averted. No additional actuating system is required; this function has customarily been fully integrated into the motor vehicle, depending upon the sensing-system requirements. In addition, the predetermined braking-point positions are capable of being adapted to a respective predetermined racetrack and to a driving behavior or ability of the driver. In this connection, it may be a question both of a single-track motor vehicle and of a two-track motor vehicle.

In an advantageous implementation variant, the present subject matter provides that predetermined advance-warning braking-point positions on the racetrack have been stored in the electronic control unit, and furthermore that an ascertainment of a respective advance-warning remaining driving time from the current position to a respective advance-warning braking-point position on the racetrack is undertaken by means of the electronic control unit. Furthermore, corresponding advance-warning limiting values for the respective advance-warning remaining driving time have been stored in the electronic control unit, and, in the event of a corresponding advance-warning limiting value being fallen short of, the electronic control unit regulates the actuating system of the engine in such a manner that the engine generates an advance-warning signal for communication to the driver. In this connection, it is favorable that the braking point is firstly announced to the driver by purposeful activation of the internal combustion engine. As a result, the driver is able to brace himself/herself for an upcoming braking procedure and can consequently react more quickly to the signal with respect to the braking-point position.

In an exemplary embodiment of the method, the present subject matter provides that for the purpose of generating the signal by means of the engine the electronic control unit regulates the actuating system in such a manner that a tractive force of the engine is interrupted for a short time. The engine is an internal combustion engine or an electric motor. By reason of the interrupted tractive force by way of signal of the engine, which for the driver feels like the motor vehicle is braking by itself, the driver accordingly identifies the braking point without having to avert his/her gaze from the roadway.

In another advantageous variant, in accordance with the present subject matter there is provision that for the purpose of generating the signal by means of the engine the electronic control unit regulates the actuating system in such a manner that an acoustic response of the engine is changed. The engine is an internal combustion engine or an electric motor. By virtue of a change in the acoustics of the engine by way of signal, the driver accordingly identifies the braking point without having to avert his/her gaze from the roadway of the racetrack. As a result, the assistance of the driver is optimized, since the driver can continue to concentrate on the racetrack or—to be more exact—on what is happening on the racetrack.

In an exemplary embodiment of the method, the present subject matter provides that for the purpose of generating the signal by means of the engine the electronic control unit regulates the actuating system by a change in an ignition angle of the engine, a change in an injection of a quantity of a fuel of the engine, a change in an activation of a throttle valve of the engine, a change in the injection of the fuel into one or more cylinders of the engine, and/or a change in a position of an exhaust flap of the engine. It is favorable that these parameters each have an influence on the acoustics of an engine, and a noticeable change in these parameters accordingly brings about a change in the acoustics of the engine.

In a preferred embodiment of the method, the sensing system ascertains the current position of the motor vehicle on the racetrack by means of a satellite-assisted detection of position and/or by means of an odometer and/or by means of a detection of predetermined reference points on the racetrack. An advantageous aspect of this is that these are conventional measures for a determination of the position of a motor vehicle and, accordingly, recourse may be had to the sensing system of the motor vehicle that is already present.

In a variant of the implementation of the method, in the case of a detection of the current position of the motor vehicle by means of an odometer the electronic control unit ascertains a distance traveled by the motor vehicle using wheel speeds of one or more wheels of the motor vehicle, and resets the distance traveled when a start/finish line on the racetrack is crossed. In this connection, the satellite-assisted detection of position can additionally ascertain the distance traveled and/or can detect the crossing of the start/finish line, and the electronic control unit can compare the respective ascertained remaining driving time with the satellite data (i.e., the distance traveled and/or the crossing of the start/finish line). In this way, the electronic control unit re-ascertains the remaining driving time up until a predetermined braking-point position for each lap driven, as a result of which the accuracy is optimized. The comparison of the ascertained data with the data of the satellite-assisted detection of position additionally improves the accuracy.

In an implementation variant, the method according to the present subject matter is carried out in such a manner that the sensing system determines the detection of the current position by the detection of the predetermined reference points on the racetrack by means of a camera-assisted image-acquisition system of the motor vehicle and/or by means of driving over induction loops beneath a tarred surface of the racetrack. As a result, the current position of the motor vehicle can be determined exactly.

In a preferred embodiment of the method, the sensing system continuously ascertains a current velocity of the motor vehicle, and the electronic control unit calculates the respective remaining driving time as a function of the current velocity of the motor vehicle, and adapts the predetermined braking-point positions and the corresponding limiting values as a function of the current velocity of the motor vehicle. An advantageous aspect of this is that the optimal braking point is determined on the basis of the current velocity of the motor vehicle, as a result of which this braking point with respect to the racetrack is improved.

Furthermore, an implementation is favorable in which the sensing system continuously ascertains the current velocity of the motor vehicle, and the electronic control unit ascertains the respective advance-warning remaining driving time as a function of the current velocity of the motor vehicle, and adapts the predetermined advance-warning braking-point positions and the corresponding advance-warning limiting values as a function of the current velocity of the motor vehicle. As a result, the advance-warning braking-point positions are adapted correspondingly to the velocity-dependent braking-point positions.

It is further advantageous if the electronic control unit generates, in addition to the signal, a further signal and outputs it by means of an indicator in the motor vehicle, by means of a warning light, a display or a head-up display. As a result, a further prompt is given to the driver, in order that the latter does not miss the optimal braking point.

In accordance with the present subject matter, furthermore an apparatus is proposed for carrying out a method for assisting a driver of a motor vehicle—a two-track or single-track motor vehicle—in driving on a predetermined racetrack, according to the preceding disclosure. The motor vehicle exhibits a sensing system, for detecting a current position of the motor vehicle on the racetrack, and an electronic control unit for regulating an actuating system of an engine of the motor vehicle. Moreover, predetermined braking-point positions on the racetrack have been stored in the electronic control unit, and a respective remaining driving time from the current position to a respective braking-point position on the racetrack is capable of being ascertained by means of the electronic control unit. In addition, corresponding limiting values for the respective remaining driving time have been stored in the electronic control unit, and, in the event of a corresponding limiting value being fallen short of, the actuating system of the engine is capable of being regulated by means of the electronic control unit in such a manner that the engine generates a signal for communication to the driver.

The features disclosed above are capable of being combined arbitrarily, to the extent that this is technically possible and these features do not conflict with one another.

Other advantageous developments of the present subject matter are characterized in the dependent claims and will be presented in more detail below together with the description of the preferred implementation of the present subject matter with reference to FIG. 1.

### BRIEF DESCRIPTION OF THE DRAWING

FIG. 1 shows a schematic view of a section of a racetrack with a motor vehicle approaching a predetermined braking-point position.

### DETAILED DESCRIPTION

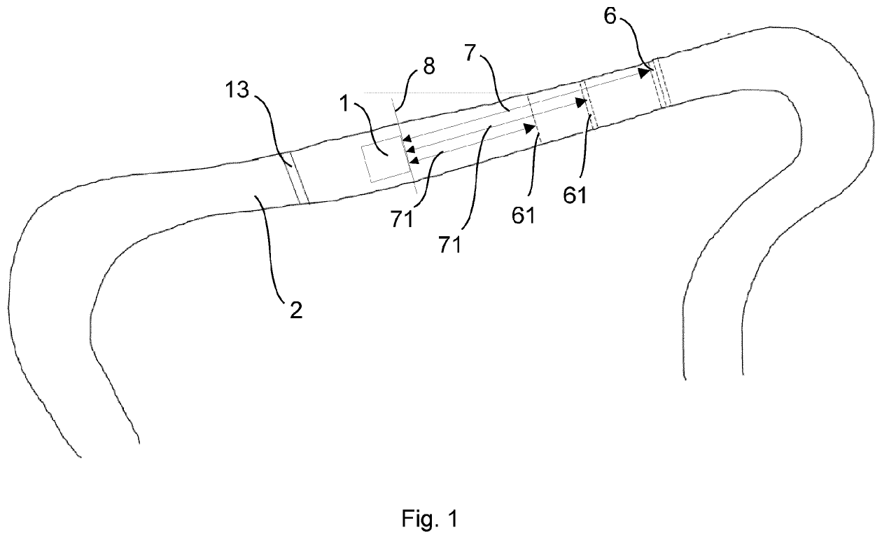

A schematic view of a section of a predetermined racetrack 2 with a motor vehicle 1 approaching a predetermined braking-point position 6 is represented in FIG. 1. The motor vehicle is a single-track motor vehicle and includes an apparatus for carrying out a method for assisting a driver of the motor vehicle 1 in driving on the racetrack 2. The motor vehicle 1 exhibits a sensing system, for detecting a current position 8 of the motor vehicle on the racetrack 2, and an electronic control unit for regulating an actuating system of an engine of the motor vehicle 1. Furthermore, predetermined braking-point positions 6 on the racetrack 2 have been stored in the electronic control unit, and a respective remaining driving time 7 from the current position 8 to a respective braking-point position 6 on the racetrack 2 is capable of being ascertained by means of the electronic control unit. In addition, corresponding limiting values for the respective remaining driving time 7 have been stored in the electronic control unit, and, in the event of a corresponding limiting value being fallen short of, the actuating system of the engine is capable of being regulated by means of the electronic control unit in such a manner that the engine generates a signal for communication to the driver. Moreover, in addition to the signal, a further signal is capable of being generated by means of the electronic control unit and capable of being output by means of a display in the motor vehicle.

In addition, predetermined advance-warning braking-point positions 61 on the racetrack have been stored in the electronic control unit, and furthermore a respective advance-warning remaining driving time 71 from the current position 8 to a respective advance-warning braking-point position 61 on the racetrack 2 is capable of being ascertained by means of the electronic control unit. Furthermore, corresponding advance-warning limiting values for the respective advance-warning remaining driving time 71 have been stored in the electronic control unit, and, in the event of a corresponding advance-warning limiting value being fallen short of, the actuating system of the engine is capable of being regulated by means of the electronic control unit in such a manner that the engine generates an advance-warning signal for communication to the driver.

In this case the engine is an internal combustion engine, and for the purpose of generating the signal by means of the engine the actuating system is capable of being regulated by means of the electronic control unit in such a manner that a tractive force of the engine is capable of being briefly interrupted. Moreover, for the purpose of generating the signal by means of the engine the actuating system is capable of being regulated by means of the electronic control unit in such a manner that an acoustic response of the engine is capable of being changed. For instance, an acoustic signal is output for an advance-warning signal, and an interruption of the traction force for a signal with respect to a predetermined braking-point position.

For the purpose of generating the signal by means of the engine, the actuating system is capable of being regulated by the electronic control unit by a change in an ignition angle of the engine, a change in an injection of a quantity of a fuel of the engine, a change in an activation of a throttle valve of the engine, a change in the injection of the fuel into one or more cylinders of the engine, and a change in a position of an exhaust flap of the engine.

The current position 8 of the motor vehicle on the racetrack 2 is capable of being ascertained by means of a satellite-assisted detection of position, by means of an odometer and by means of a detection of predetermined reference points on the racetrack 2.

In the case of a detection of the current position 8 by the sensing system by means of an odometer, a distance traveled by the motor vehicle 1 is capable of being ascertained by the electronic control unit using wheel speeds of one or more wheels of the motor vehicle 1, and the electronic control unit resets the distance traveled when a start/finish line 13 on the racetrack 2 is crossed. The respective ascertained remaining driving time 7 is capable of being ascertained by the electronic control unit. Moreover, the detection of the current position 8 by the detection of the predetermined reference points on the racetrack 2 is capable of being determined by the sensing system by means of a camera-assisted image-acquisition system of the motor vehicle 1 and by means of driving over induction loops beneath a tarred surface of the racetrack 2.

Moreover, a current velocity of the motor vehicle is capable of being determined continuously by the sensing system, and in the course of the ascertainment of the respective remaining driving time 7 by the electronic control unit the remaining driving time 7 is capable of being ascertained as a function of the current velocity of the motor vehicle, and the predetermined braking-point position 6 and the corresponding limiting values are capable of being adapted as a function of the current velocity of the motor vehicle. In addition, in the course of the ascertainment of the respective advance-warning remaining driving time 71 by the electronic control unit this driving time is capable of being ascertained as a function of the current velocity of the motor vehicle, and the predetermined advance-warning braking-point positions 61 and the corresponding advance-warning limiting values are capable of being adapted as a function of the current velocity of the motor vehicle.

The present subject matter is not restricted in its implementation to the preferred exemplary embodiments specified above. Rather, a number of variants are conceivable that make use of the solution presented, even in the case of implementations of a fundamentally different nature.

1.-12. (canceled)

13. A method for assisting a driver of a motor vehicle in driving on a predetermined racetrack, wherein the motor vehicle comprises a sensing system for detecting a current position of the motor vehicle on the racetrack, and an electronic control unit for regulating an actuating system of an engine of the motor vehicle, wherein predetermined braking-point positions on the racetrack have been stored in the electronic control unit, the method comprising:
continuously detecting the current position of the motor vehicle on the racetrack; and
ascertaining a respective remaining driving time from the current position to a respective braking-point position on the racetrack by using the electronic control unit, wherein
corresponding limiting values for the respective remaining driving time are stored in the electronic control unit, and
in response to a corresponding limiting value not being reached the electronic control unit regulates the actuating system of the engine such the engine generates a signal for communication to the driver.

14. The method according to claim 13, wherein
predetermined advance-warning braking-point positions on the racetrack have been stored in the electronic control unit, and the method further comprises:
ascertaining a respective advance-warning remaining driving time from the current position to a respective advance-warning braking-point position on the racetrack by the electronic control unit, wherein
corresponding advance-warning limiting values for the respective advance-warning remaining driving time are stored in the electronic control unit, and
in response to a corresponding advance-warning limiting value not being reached, the electronic control unit regulates the actuating system of the engine such that the engine generates a warning signal for communication to the driver.

15. The method according to claim 13, wherein
the generated signal regulates the actuating system such that a tractive force of the engine is interrupted a short time, wherein
the engine is an internal combustion engine or an electric motor.

16. The method according to claim 13, wherein
the generated signal regulates the actuating system such that an acoustic response of the engine is changed, wherein
the engine is an internal combustion engine or an electric motor.

17. The method according to claim 16, wherein
the generated signal regulates the actuating system by:
a change in an ignition angle of the engine,
a change in an injection of a quantity of a fuel of the engine,
a change in an activation of a throttle valve of the engine,
a change in the injection of the fuel into one or more cylinders of the engine, and/or
a change in a position of an exhaust flap of the engine.

18. The method according to claim 13, wherein
the sensing system ascertains the current position of the motor vehicle on the racetrack using:
satellite data,
an odometer, and/or
a detection of predetermined reference points on the racetrack.

19. The method according to claim 18, wherein in response to a detection of the current position of the motor vehicle using an odometer:
ascertaining, by the electronic control unit, a distance traveled by the motor vehicle using wheel speeds of one or more wheels of the motor vehicle, and
resetting, by the electronic control unit, the distance traveled when a start/finish line on the racetrack is crossed, wherein
the satellite data comprises one or more of:
position, distance traveled, and/or crossing of the start/finish line, and
the electronic control unit compares the respective ascertained remaining driving time with the satellite data.

20. The method according to claim 18, wherein
the sensing system ascertains the current position by detecting the predetermined reference points on the racetrack:
by using a camera-assisted image-acquisition system of the motor vehicle, and/or
by driving over induction loops beneath a tarred surface of the racetrack.

21. The method according to claim 13, further comprising:
continuously ascertaining, by the sensing system, a current velocity of the motor vehicle,
ascertaining, by the electronic control unit, the respective remaining driving time as a function of the current velocity of the motor vehicle, and
adapting the predetermined braking-point positions and the corresponding limiting values, by the electronic control unit, as a function of the current velocity of the motor vehicle.

22. The method according to claim 14, further comprising:
continuously ascertaining, by the sensing system, a current velocity of the motor vehicle,
ascertaining, by the electronic control unit, the respective advance-warning remaining driving time as a function of the current velocity of the motor vehicle, and
adapting, by the electronic control unit, the predetermined advance-warning braking-point positions and the corresponding advance-warning limiting values as a function of the current velocity of the motor vehicle.

23. The method according to claim 13, wherein
the electronic control unit generates, in addition to the signal, a further signal and outputs the signal via a warning light, a display, or a head-up display of the motor vehicle.

24. An apparatus for carrying out a method for assisting a driver of a two-track or single-track motor vehicle in driving on a predetermined racetrack, comprising:
a sensing system, configured to detect a current position of the motor vehicle on the racetrack, and
an electronic control unit configured to:
regulate an actuating system of an engine of the motor vehicle,
store predetermined braking-point positions on the racetrack,
ascertain a respective remaining driving time from the current position to a respective braking-point position on the racetrack, and
store corresponding limiting values for the respective remaining driving time, wherein
in response to a corresponding limiting value not being reached, the actuating system of the engine is configured to be regulated by the electronic control unit such that the engine generates a signal for communication to the driver.
